(19) United States
(12) Patent Application Publication
(10) Pub. No.: US 2026/0251536 A1
(43) Pub. Date: Aug. 27, 2026

(54) SAMPLING DEVICE, SAMPLING METHOD AND METHOD FOR CLEANING A SAMPLING DEVICE

(71) Applicant: Bürkle GmbH, Bad Bellingen (DE)

(72) Inventor: Ralf Breitmoser, Staufen (DE)

(21) Appl. No.: 19/545,679

(22) Filed: Feb. 20, 2026

(30) Foreign Application Priority Data
Feb. 25, 2025 (DE) 10 2025 107 121.7

(51) Int. Cl. G01N 1/12

(52) U.S. Cl. CPC G01N 1/12

(57) ABSTRACT

A sampling device that includes a sample receiving element having a sample receiving chamber, a hollow tubular element having an opening and accommodates the sample receiving element in an interior space mounted so as to be rotatable about a longitudinal axis of the sampling device. Rotation between the sample receiving element and the tubular element allows a sample to pass through the opening into the sample receiving chamber The sampling device also has a locking mechanism configured to block a rotational movement of the handle with respect to the tubular element when the handle is in a locking position, and is further configured to allow a rotational movement of the handle with respect to the tubular element when the handle is brought from the locking position to an intermediate position by relative movement of the handle with respect to the sample receiving element and/or the tubular element.

### TECHNICAL FIELD

The invention relates to a sampling device for taking a sample, preferably a liquid, powdery or granular sample, and to a sampling method using such a sampling device.

Furthermore, the invention relates to a method for cleaning a sampling device.

### BACKGROUND

Conventionally, a wide variety of sampling devices can be used to take liquid, powdery or fine-grained or granular or coarse-grained samples from a sample material or a total sample volume. Depending on the application, these differ in their design and dimensions.

The primary function of sampling is often to take a representative sample from the sample material or the total sample volume required for the analysis, for example to take a contamination-free sample. Subsequently, reliable statements can be made about the quality, characteristics or composition of the sample and thus conclusions can be drawn about the sample material, e.g. by means of an analysis in the laboratory.

Conventional sampling devices for taking a sample without contamination, for example, are designed in such a way that, at least when the sampling device is used as intended, non-contact sampling, i.e. without the person taking the sample coming into contact with the sample, is guaranteed in order to avoid contamination of the sample. Non-contact sampling is also particularly important if the sample contains material that is potentially hazardous or harmful to humans or the environment. In this context, it must be possible to take the sample in such a way that no material is spilled or leaks out.

In this context, sampling device in the form of so-called sampling spears are known from the prior art. This is, for example, a rod-shaped sampling device with an outer shell (outer tube) and a sampling rod (inner tube), wherein the sampling rod and the outer shell of the sampling device are arranged concentrically and can be rotated in relation to each other. The sampling rod comprises recesses (sample receiving chambers) or indentations being configured to receive the sample, wherein the outer shell has corresponding openings so that, when the sampling spear is inserted into the sample or total sample volume and sampling rod and outer shell are rotated in relation to each other, the sample can pass through the openings of the outer shell into the recesses of the sampling rod. The sampling rod is then rotated (again) so that the outer shell serves to close or seal the recesses of the sampling rod.

If such sample spears have plurality of sample receiving chambers, for example sample receiving chambers arranged offset in the circumferential direction and in the longitudinal direction of the sample spear, which are to be filled in a specific sequence and, if necessary, also sealed, it is often necessary to provide a positive guide; This, for example, uses a positive guide groove in the outer tube and a projection/pin in the inner tube guided in the positive guide groove to precisely define the possible movements so that the sample spear can be moved into specific positions for filling or closing the sample receiving chambers, and also so that the sample receiving chambers can be filled and closed in a predetermined sequence.

In such sample spears, the opening or sample opening is positioned at a defined location on the sampling device or on the outer tube. In accordance with the forced guidance, the sample receiving chambers formed in the inner tube are shifted axially so that they are congruent with the sample opening in the outer tube when sampling is performed. Accordingly, the sample opening is located at a large distance from the foremost tip or tip portion of the sampling, as the axially offset sample receiving chambers located one behind the other must be accommodated in the outer tube. However, this requirement for forced guidance impairs the handling of the sampling device, limiting the possibility of taking samples close to the ground.

Therefore, the object of the invention can be seen in further developing conventional sampling devices and sampling methods in such a way that handling in connection with sampling and/or cleaning is facilitated or simplified.

### SUMMARY OF THE INVENTION

This object is solved by the features of the independent claims.

Advantageous embodiments and modifications of the invention are set out in the dependent claims.

The sampling device according to the invention is configured for taking a sample, preferably a liquid, powdery or granular sample, the sampling device comprising: an elongate sample receiving element (inner tube), which has at least one sample receiving chamber, a hollow cylindrical tubular element (hollow cylindrical outer tube) comprising at least one opening and accommodating the sample receiving element in an interior space mounted so as to be rotatable about a longitudinal axis of the sampling device in such a way that, upon relative rotation between the sample receiving element and the tubular element, a sample can pass through the opening into the sample receiving chamber and/or the opening can be closed, a handle coupled to the sample receiving element such that a rotational movement of the handle about the longitudinal axis is converted into a rotational movement of the sample receiving element, and further coupled to the sample receiving element such that a relative movement of the handle with respect to the sample receiving element in the direction of the longitudinal axis is enabled, and a locking mechanism being configured to block rotational movement of the handle with respect to the tubular element when the handle is in a locked position, and further configured to allow rotational movement of the handle with respect to the tubular element when the handle is brought from the locked position to an intermediate position by relative movement of the handle with respect to the sample receiving element and/or the tubular element in the direction of the longitudinal axis (longitudinal direction of the sampling device).

By using the sampling device according to the invention, it is possible to form the sample opening (opening in the outside/outer tube) close to the tip or tip portion of the sampling. Sampling close to the ground is therefore also possible. In addition, the handling of the sampling according to the invention is also improved, since the movement of the inner tube in relation to the outer tube is not restricted to the same extent as in the prior art by means of a forced guide.

The sampling device according to the invention can be advantageously designed in such a way that the locking mechanism comprises a locking projection on the handle side and a control track on the tubular element side, wherein the control track fixes the locking position by the locking projection engaging in a locking recess of the control track, and sets the intermediate position by the locking projection being guided in a sliding manner on the control track. Of course, in an alternative embodiment, it is also conceivable to provide the locking projection on the tubular element side and the control track on the handle side.

Furthermore, the sampling device according to the invention can be realized in such a way that the locking mechanism defines a plurality of locking positions and respective intermediate positions lying between the locking positions, wherein a respective locking position corresponds to a position of the handle to the tubular element in which a sample can enter the sample receiving chamber via the opening or the opening is closed.

In addition, the sampling device according to the invention can be formed in such a way that the sample receiving element comprises a plurality of sample receiving chambers spaced apart in the circumferential direction and in the longitudinal direction in the same axial arrangement and at least one closure portion.

Moreover, the sampling device according to the invention can be further designed in such a way that the locking mechanism comprises a biasing mechanism that biases the handle in the direction of the tubular element at least in sections.

Furthermore, the sampling device according to the invention can be realized in such a way that the biasing mechanism is formed by a connecting element, a handle portion of the handle and a spring element, wherein the connecting element has an end portion on the sample receiving element side and an end portion on the handle side, wherein the end portion on the sample receiving element side is connected to the sample receiving element in a rotationally fixed manner (via a form-fitting connection) and is mounted in the tubular element in a rotationally movable manner and is fixed in an axially immovable manner in the direction of the handle, wherein the end portion on the handle side interacts with the handle portion in such a way that the end portion is mounted so as to be axially movable and non-rotatable in relation to the handle portion, and the spring element is arranged between the end portion on the handle side and a step/recess of the handle portion in such a way that the spring element can be compressed or expanded during relative movement between the end portion on the handle side and the handle portion.

Furthermore, the sampling device according to the invention can be designed such that the handle further comprises a compression portion which is rigidly connected to the connecting element and is movable relative to the handle such that upon relative movement of the compression portion relative to the handle, the spring element is compressed or expanded. This allows, for example, the sample receiving element to be moved axially together with the compression portion and at least partially out of the outer tube when the compression portion is moved in the direction of the outer tube relative to the handle and the outer tube when the tip of the sampling device is removed.

Furthermore, the sampling device according to the invention can be formed in such a way that the tubular element is provided at one end with the handle and at another end with a removable tip portion, which, as intended, is first inserted into the sample volume containing the sample when the sample is taken, wherein the sample receiving element can be removed from the tubular element when the tip portion is removed.

The sampling method according to the invention for taking a sample, in particular a liquid, powdery or granular sample, from a total sample quantity using the sampler according to the invention comprises the following steps:

Insertion of the sampling device into the total sample volume while the handle is in the locked position and the opening is closed,

Moving the handle at least in the direction of the longitudinal axis relative to the sample receiving element into an intermediate position;

Turning the handle into a further locking position so that the sample receiving chamber is accessible via the opening for taking the sample;

Insertion of the sample into the sample receiving chamber;

Moving the handle at least in the direction of the longitudinal axis relative to the sample receiving element into an intermediate position;

Rotating the handle relative to the tubular element so that the opening is closed or another sample receiving chamber is accessible via the opening for taking the sample.

Once sampling is complete, the sampling device can finally be removed from the total sample volume with the opening closed.

This results in the properties and advantages explained in connection with the sampling device according to the invention in the same or similar way, which is why reference is made to the above explanations in connection with the sampling device according to the invention in order to avoid repetition.

The method according to the invention for cleaning the sampling device according to the invention is preferably provided for cleaning the sampling device after performing a sampling according to the sampling method according to the invention and comprises the following steps: Compressing the compression portion of the handle so that the compression portion moves relative to the tubular element in the direction of the tubular element, wherein the sample receiving element is at least partially pushed out of the tubular element.

This results in the properties and advantages explained in connection with the sampling device according to the invention in the same or similar way, which is why reference is made to the above explanations in connection with the sampling device according to the invention in order to avoid repetition.

A further sampling device for taking a sample, preferably a liquid, powdery or granular sample, comprises: an elongate sample receiving element, which has at least one sample receiving chamber, a hollow cylindrical tubular element comprising at least one opening and accommodating the sample receiving element in an interior space mounted so as to be rotatable about a longitudinal axis of the sampling device in such a way that, upon relative rotation between the sample receiving element and the tubular element, a sample can pass through the opening into the sample receiving chamber and/or the opening can be closed, a handle which is coupled to the sample receiving element in such a way that a translatory relative movement of the handle along the longitudinal axis in relation to the sample receiving element is converted into a rotational movement of the sample receiving element, preferably by means of a screw drive with a handle configured at least partially as a threaded shaft and a sample receiving element configured at least partially as an internally threaded spindle.

This results in the properties and advantages explained in connection with the sampling device according to the invention in the same or similar way, which is why reference is made to the above explanations in connection with the sampling device according to the invention in order to avoid repetition.

### BRIEF DESCRIPTION OF THE DRAWINGS

A preferred embodiment of the invention is explained below by way of example with reference to the figures.

It shows:

FIG. 1 shows a schematic representation of a sampling device according to the invention in a longitudinal direction of the sampling device;

FIG. 2 shows a further schematic representation of a sampling device according to the invention of FIG. 1 in a sectional view in the longitudinal direction of the sampling device in a partially disassembled state;

FIGS. 3a-c show schematic representations of the sampling device according to the invention in different positions in respective perspective views; and

FIGS. 4a-c show schematic representations of the sampling device according to the invention in different states in respective sectional views.

### DETAILED DESCRIPTION

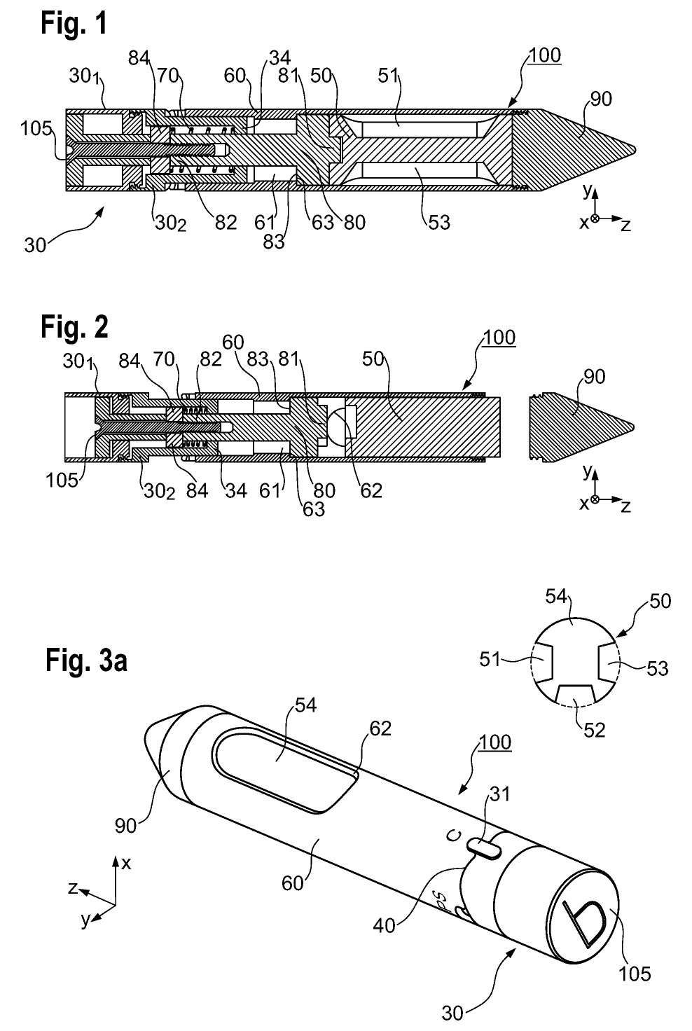

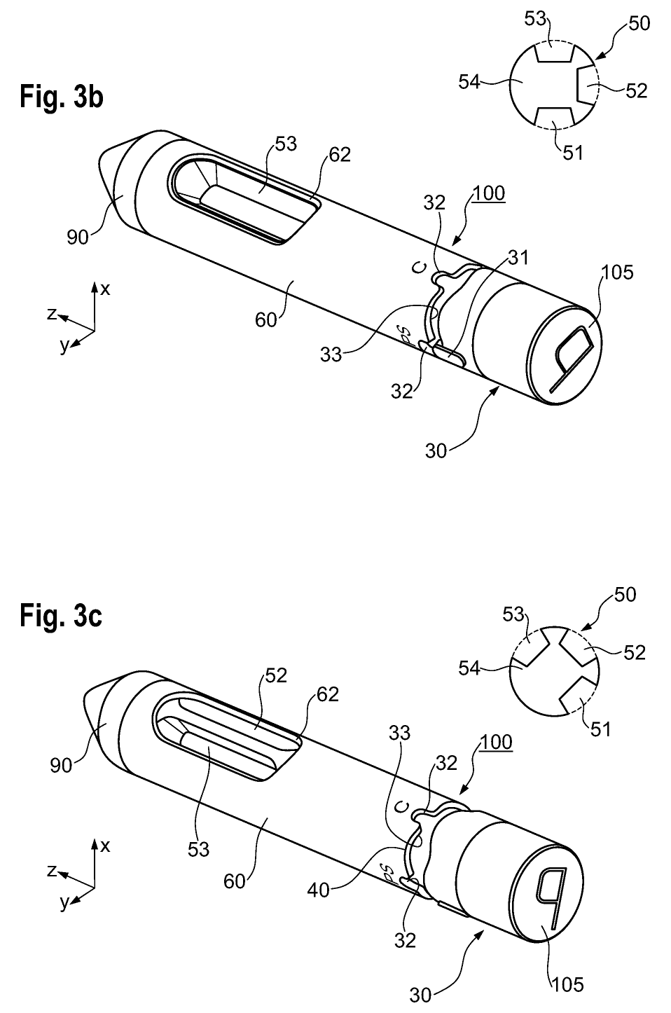

FIG. 1 shows a schematic representation of a sampling device 100 according to the invention in a sectional view in the longitudinal direction or in the direction of a longitudinal axis of the sampling device 100 (corresponding to a z-axis of the x-y-z coordinate system shown), while FIG. 2 shows a further schematic representation of the sampling device 100 according to the invention of FIG. 1 in a sectional view in the longitudinal direction of the sampling device 100 in a partially disassembled state. Furthermore, FIGS. 3a-c show schematic representations of the sampling device 100 according to the invention in different positions or handle positions, which are described in more detail below, in respective perspective views.

The sampling device 100 according to the invention is configured for taking a sample, for example a liquid, powdery or granular sample, and essentially comprises an elongate sample receiving element 50, a hollow cylindrical tubular element 60, a handle 30 and a locking mechanism with a biasing mechanism.

As can be clearly seen in FIG. 1 in particular, the handle 30 is provided at one end of the tubular element 60 and a removable tip portion 90 is provided at its other end (see also FIG. 2, for example), the tip portion 90 being inserted first into the sample volume containing the sample as intended when the sample is taken.

The sample receiving element (inner tube) 50 is elongated or rod-shaped with a circular cross-section or at least in sections in the form of a (solid) cylinder. In this embodiment example, the sample receiving element 50 has a plurality of sample receiving chambers 51, 52 and 53 spaced apart in the circumferential direction and arranged in the same axial arrangement in the longitudinal direction, and at least one closing portion 54, as illustrated in FIGS. 3a-c on the basis of the cross-sectional view of the sample receiving element 50.

Each sample receiving chamber 51, 52 and 53 is formed as an elongated recess in the sample receiving element 50, for example in the form of an elongated groove, in particular as a round groove with a specific groove depth.

The closing portion 54 is formed by a cylindrical segment-like section of the sample receiving element 50 between two sample receiving chambers 51 and 53. As a result, the sample receiving chambers 51 and 52 as well as 52 and 53 are arranged at an equal distance in the circumferential direction, whereby the sample receiving chambers 51 and 53 are arranged at a greater distance in the circumferential direction due to the closing portion 54 arranged therebetween.

In the case shown, the hollow cylindrical tubular element 60 has exactly one opening 62, which connects an environment of the tubular element 60 with a cylindrical interior 61 of the tubular element 60.

The sample receiving element 50 is accommodated in the interior space 61 of the tubular element 60 and is rotatable mounted about a longitudinal axis of the sampling device 100 (corresponding to the z-axis of the coordinate system shown) in such a way that a sample can pass through the opening 62 into each of the sample receiving chambers 51, 52 and 53 via a relative rotation between the sample receiving element (inner tube) 50 and the tubular element (outer tube) 60 and the opening 62 can be closed via the closing portion 54.

The manually operable handle 30 comprises a first handle portion 30₁ and a second handle portion 30₂. As can be clearly seen in FIGS. 1 and 2, the first handle portion 30₁ and the second handle portion 30 ₂ are each sleeve-shaped, with the first handle portion 30₁ being partially accommodated in the second handle portion 30₂ and firmly connected thereto.

In the case shown, the handle 30 is coupled to the sample receiving element 50 in such a way that a rotational movement of the handle 30 about the longitudinal axis is converted or translated into a rotational movement of the sample receiving element 50. Furthermore, the handle 30 is coupled to the sample receiving element 50 in such a way that a relative movement of the handle 30 with respect to the sample receiving element 50 in the longitudinal direction or in the direction of the longitudinal axis of the sampling device 100 is enabled.

The implementation of this relative mobility of the handle 30 in relation to the sample receiving element 50, in particular in interaction with the locking mechanism and its biasing mechanism, is explained in more detail below.

The locking mechanism is configured to block rotational movement of the handle 30 with respect to the tubular element (outer tube) 60 when the handle 30 is in a locked position, and to allow rotational movement of the handle 30 with respect to the tubular element 60 when the handle 30 is brought from the locked position to an intermediate position by relative movement of the handle 30 with respect to the sample receiving element 50 or the tubular element 60, i.e. away from the sample receiving element 50 or the tubular element 60, in the longitudinal direction.

In order to realize this, the locking mechanism has a handle-side locking projection 31, which is provided on the second handle portion 30₂, and a control track 40 on the tubular element side.

The control track 40 can, for example, be formed by an edge region of the tubular element 60 at its handle-side end, with which the locking projection 31 is in contact. In this case, the control track 40 determines the locking position by the locking projection 31 engaging or entering a locking recess 32 of the control track 40 (see in particular FIGS. 3b and 3c), which forms a positive fit with the locking projection 31 in the circumferential direction of the handle 30 or the tubular element 60.

On the other hand, an intermediate position 33 is determined by means of the control track 40 in that the locking projection 31 is guided in a sliding manner on sections of the control track 30 arranged between respective locking recesses 32 in the circumferential direction of the handle 30 or the tubular element 60.

In this embodiment, the locking mechanism has in particular four locking positions, a first locking position for positioning the first sample receiving chamber 51 aligned with the opening 62, a second locking position for positioning the second sample receiving chamber 52 aligned with the opening 62, a third locking position for positioning the third sample receiving chambers 53 aligned with the opening 62 and a fourth locking position for positioning the closing portion 54 aligned with the opening 62 to close the opening 62, as can be seen in particular from FIGS. 3a-c in particular. In particular, FIG. 3a shows the fourth locking position, in which the opening 62 is closed, while FIG. 3b shows the third locking position, in which the sample receiving chamber 53 is accessible via the opening 62. FIG. 3c, on the other hand, shows a state of the sampler 100 in an intermediate position 33 between the second locking position and the third locking position of the sampling device 100.

The respective intermediate positions between the locking positions allow the locking projection 31 to slide on the control track 40.

Thus, a respective locking position corresponds to a position of the handle 30 relative to the tubular element 60 in which a sample can enter a respective sample receiving chamber 51, 52, 53 via the opening 62 or the opening 62 is closed.

In order to secure or hold the handle 30 or locking projection 31 in the respective locking positions, the locking mechanism has the biasing mechanism, which urges or biases the handle 30 in the direction of the tubular element 60. For this purpose, the biasing mechanism is formed by a connecting element 80, the handle 30 and a spring element 70.

The connecting element 80 has an end portion 81 on the sample receiving element side and an end portion 82 on the handle side.

In this case, the end portion 81 on the sample receiving element side is connected to the sample receiving element 50 in a rotationally fixed manner and is mounted in the tubular element 60 in a rotationally movable manner and is axially fixed in the direction of the handle 30. This is realized, for example, by the tubular element 60 having a step/recess 63 on its inner wall facing away from the handle 30, which is in contact with a step/recess 83 of the end portion 81 of the sample receiving element facing the handle 30. The step/recess 63 on the inner wall of the tubular element 60 and the step/recess 83 of the end portion 81 of the connecting element 80 on the sample receiving element side thus form a positive fit in the direction of the handle 30, but not in the opposite direction.

Furthermore, the sample receiving element side end portion 81 is non-rotatably connected to the sample receiving element 50 via a positive fit; this positive fit is produced, for example, by a projection on the sample receiving element side end portion 81, which engages non-rotatably in a recess of the sample receiving element 50. However, the sample receiving element 50 can be released from the positive fit in the direction of the longitudinal axis when the sample receiving element 50 is moved away from the end portion 81 on the sample receiving element side in the axial direction.

The handle-side end portion 82 of the connecting element 80 extends axially partially through the second handle portion 30₂ and is accommodated therein.

The handle-side end portion 82 of the connecting element 80 interacts with the second handle portion 30₂ in such a way that the first and second handle portions 30₁ and 30₂ are mounted so as to be axially movable and rotationally fixed with respect to the connecting element 80. The spring element 70 is arranged between the handle-side end portion 82 and the second handle portion 30₂in such a way that the spring element 70 can be compressed or expanded during relative movement between the handle-side end portion 82 and the handle 30.

As can be seen in the case shown in FIG. 1, the second handle portion 30₂ slidingly receives the connecting element 80 or the handle-side end portion 82 of the connecting element 80 for this purpose. The handle-side end portion 82 forms a step/recess 84, so that the spring element 70 is supported between the step/recess 84 of the handle-side end portion 82 and a step/recess 34 formed by the second handle portion 30₂. The step/recess 84 of the handle portion 82 is accommodated in the second handle portion 30₂ in a manner that allows it to move in the axial direction but cannot be rotated or turned relative to the second handle portion 30₂ due to a positive connection or anti-rotation device. For example, the inner wall of the second handle portion 30₂ and the step/recess 84 may be formed in the manner of a polygonal shaft guide, i.e. in the manner of an anti-rotation guide in which linear movement is enabled but rotation is prevented.

Furthermore, the handle 30 has in its first handle portion 30₁a compression portion 105 accommodated therein, which is rigidly connected to the connecting element 80 or the handle-side end portion 82 of the connecting element 80, for example via a bolt screw connection, and is movable relative to the first handle portion 30₁ such that the spring element 70 can be compressed or expanded during relative movement of the compression portion 105 relative to the first handle portion 30₁ in the direction of the longitudinal axis.

Accordingly, with the tip portion 90 disassembled, the sample receiving element 50 can be at least partially removed from the tubular element 60 by actuating the compression portion 105 and then removed when the compression portion 105 is moved toward and relative to the tubular element 60.

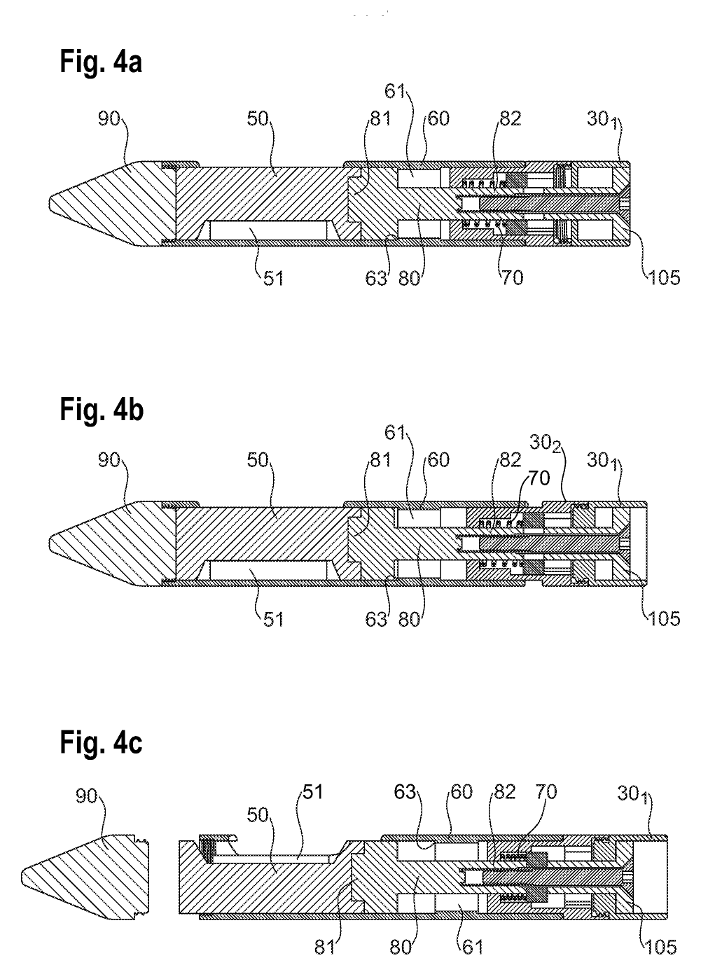

To better illustrate this mechanism, FIGS. 4a-c are used below, which show schematic representations of the sampling device 100 according to the invention in different states in respective sectional views.

FIG. 4a shows a state of the sampling device 100 that corresponds to the state in FIG. 1. In other words, the sampling device is in the operational and fully assembled state, with the handle 30 in the locked position in which the closing portion 54 closes the opening.

FIG. 4b shows a further state of the sampling device 100, in which the handle 30 is moved away from the tubular element 60 in the longitudinal direction and is transferred to an intermediate position. This compresses the spring element 70, as can be seen in particular from the offset compression portion 105 compared to FIG. 4a. This means that the handle 30 has performed a relative movement to the compression portion 105 and thus to the connecting element 80. When the handle 30 is released, the still compressed spring element 70 relaxes and moves the handle 30 in the direction of the tubular element 60.

Finally, FIG. 4c shows a further state of the sampling device 100, in which the tip portion 90 of the sampling device 100 has been disassembled and the compression portion 105 has been moved in the direction of the tubular element 60 relative thereto in the longitudinal direction, so that the sample receiving element 50 is at least partially pushed out of the end portion of the tubular element 60. This means that sample receiving element 50 can be easily removed and cleaned separately, for example.

Accordingly, the operation of the sampling device 100 or the sampling is carried out according to the following sampling method according to the invention:

First, the sampling device 100 is inserted into a total sample volume while the handle 30 is in a locked position with the opening 62 closed.

Subsequently, the handle 30 is moved in the longitudinal direction relative to the sample receiving element 100 and by rotation into an intermediate position, in order to then rotate it further, namely into a further corresponding locking position, so that one of the sample receiving chambers 51, 52, 53 is accessible via the opening for removing the sample. This can be repeated until each sample receiving chamber 51, 52, 53 is filled with a sample.

Once a respective sample has been inserted into one or more of the sample receiving chambers 51, 52, 53, the handle 30 is rotated relative to the tubular element 60 into a further locking position in which the opening is closed.

The sampling device 100 is then removed from the total sample volume.

After performing a sampling according to the sampling method described above, the method according to the invention can be carried out to clean the sampling device 100. The tip portion 90 is then first removed from the tubular element 60. Subsequently, the compression portion 105 of the handle 30 is moved relative to the tubular element 60 so that the compression portion moves relative to the tubular element 60 towards the sample receiving element 50, wherein the sample receiving element 30 is at least partially pushed out of the tubular element 60 and can be removed, as shown in FIG. 4c.

The features of the invention disclosed in the above description, in the drawings and in the claims may be essential for the realization of the invention either individually or in any combination.

Aspects of the invention:

According to a first aspect of the invention a sampling device (100) for taking a sample, preferably a liquid, powdery or granular sample, the sampling device (100) comprises:

an elongate sample receiving element (50), which has at least one sample receiving chamber (51),

a hollow cylindrical tubular element (60) comprising at least one opening (62) and accommodating the sample receiving element (50) in an interior space (61) mounted so as to be rotatable about a longitudinal axis of the sampling device (100) in such a way that, upon relative rotation between the sample receiving element (50) and the tubular element (60), a sample can pass through the opening (62) into the sample receiving chamber (51) and/or the opening (62) can be closed,

a handle (30) coupled to the sample receiving element (50) such that a rotational movement of the handle (30) about the longitudinal axis is converted into a rotational movement of the sample receiving element (50), and further coupled to the sample receiving element (50) such that a relative movement of the handle with respect to the sample receiving element (50) in the direction of the longitudinal axis is enabled, and

a locking mechanism being configured to block rotational movement of the handle (30) with respect to the tubular element (60) when the handle (30) is in a locked position, and further configured to allow rotational movement of the handle (30) with respect to the tubular element (60) when the handle (30) is brought from the locked position to an intermediate position by relative movement of the handle with respect to the sample receiving element (50) and/or the tubular element (60) in the direction of the longitudinal axis.

According to a second aspect of the invention the sampling device (100) according to the first aspect requires that the locking mechanism comprises a locking projection on the handle side and a control track on the tubular element side, wherein the control track fixes the locking position by the locking projection engaging in a locking recess of the control track, and sets the intermediate position by the locking projection being guided in a sliding manner on the control track.

According to a third aspect of the invention the sampling device according to the first or second aspect requires that the locking mechanism defines a plurality of locking positions and respective intermediate positions lying between the locking positions, wherein a respective locking position corresponds to a position of the handle to the tubular element (60) in which a sample can enter the sample receiving chamber (51) via the opening (62) or the opening (62) is closed.

According to a fourth aspect of the invention the sampling device (100) according to the first, second or third aspect requires that the sample receiving element (50) comprises a plurality of sample receiving chambers (51) spaced apart in the circumferential direction and in the longitudinal direction in the same axial arrangement and at least one closure portion.

According to a fifth aspect of the invention the sampling device (100) according to the first, second, third or fourth aspect requires that the locking mechanism comprises a biasing mechanism that biases the handle in the direction of the tubular element (60) at least in sections.

According to a sixth aspect of the invention the sampling device (100) according to the fifth aspect requires that the biasing mechanism is formed by a connecting element (80), a handle portion (30₂) of the handle and a spring element (70),

wherein the connecting element (80) has an end portion (81) on the sample receiving element side and an end portion (82) on the handle side,

wherein the end portion (81) on the sample receiving element side is connected to the sample receiving element (50) in a rotationally fixed manner and is mounted in the tubular element (60) in a rotationally movable manner and is fixed in an axially immovable manner in the direction of the handle,

wherein the end portion (82) on the handle side interacts with the handle portion (30₂) in such a way that the end portion (82) is mounted so as to be axially movable and non-rotatable in relation to the handle portion (30₂), and the spring element (70) is arranged between the end portion (82) on the handle side and a step (34) of the handle portion (₃₀₂) in such a way that the spring element (70) can be compressed or expanded during relative movement between the end portion (82) on the handle side and the handle portion (30₂).

According to a seventh aspect of the invention the sampling device (100) according to sixth aspect requires that the handle (30) further comprises a compression portion which is rigidly connected to the connecting element (80) and is movable relative to the handle such that upon relative movement of the compression portion relative to the handle, the spring element (70) is compressed or expanded.

According to an eight aspect of the invention the sampling device (100) according to one of the aforementioned aspects further requires that the tubular element (60) is provided at one end with the handle (30) and at another end with a removable tip portion (90), which, as intended, is first inserted into the sample volume containing the sample when the sample is taken, wherein the sample receiving element (50) can be removed from the tubular element (60) when the tip portion (90) is removed.

According to a ninth aspect of the invention a sampling method for taking a sample, in particular a liquid, powdery or granular sample, from a total sample volume using a sampling device (100) according to the first, second, third, fourth, fifth, sixth, seventh or eighth aspect comprises the following steps:

Insertion of the sampling device (100) into the total sample volume while the handle is in the locked position and the opening is closed,

Moving the handle (30) at least in the direction of the longitudinal axis relative to the sample receiving element into an intermediate position;

Turning the handle (30) into a further locking position so that the sample receiving chamber is accessible via the opening for taking the sample;

Insertion of the sample into the sample receiving chamber (51);

Moving the handle (30) at least in the direction of the longitudinal axis relative to the sample receiving element into an intermediate position;

Rotating the handle (30) relative to the tubular element so that the opening is closed or another sample receiving chamber is accessible via the opening for taking the sample.

According to a tenth aspect of the invention a method for cleaning a sampling device (100) according to the first, second, third, fourth, fifth, sixth, seventh or eighth aspect, in particular for cleaning the sampling device (100) after performing a sampling according to the sampling method according to the ninth aspect, comprises the following steps:

Compressing the compression portion of the handle (30) so that the compression portion moves relative to the tubular element (60) in the direction of the tubular element (60), wherein the sample receiving element is at least partially pushed out of the tubular element.

According to a eleventh aspect of the invention a sampling device (100) for taking a sample, preferably a liquid, powdery or granular sample, comprises:

an elongate sample receiving element (50), which has at least one sample receiving chamber (51),

a hollow cylindrical tubular element (60) comprising at least one opening (62) and accommodating the sample receiving element (50) in an interior space (61) mounted so as to be rotatable about a longitudinal axis of the sampling device (100) in such a way that, upon relative rotation between the sample receiving element (50) and the tubular element (60), a sample can pass through the opening (62) into the sample receiving chamber (51) and/or the opening (62) can be closed,

a handle (30) which is coupled to the sample receiving element (50) in such a way that a translatory relative movement of the handle (30) along the longitudinal axis in relation to the sample receiving element (50) is converted into a rotational movement of the sample receiving element (50), preferably by means of a screw drive with a handle (30) configured at least partially as a threaded shaft and a sample receiving element (50) configured at least partially as an internally threaded spindle.

1. Sampling device (100) for taking a sample, the sampling device (100) comprising:
an elongate sample receiving element (50), which has at least one sample receiving chamber (51),
a hollow cylindrical tubular element (60) comprising at least one opening (62) and accommodating the sample receiving element (50) in an interior space (61) mounted so as to be rotatable about a longitudinal axis of the sampling device (100) in such a way that, upon relative rotation between the sample receiving element (50) and the tubular element (60), a sample can pass through the opening (62) into the sample receiving chamber (51) and/or the opening (62) can be closed,
a handle (30) coupled to the sample receiving element (50) such that a rotational movement of the handle (30) about the longitudinal axis is converted into a rotational movement of the sample receiving element (50), and further coupled to the sample receiving element (50) such that a relative movement of the handle with respect to the sample receiving element (50) in the direction of the longitudinal axis is enabled, and
a locking mechanism being configured to block rotational movement of the handle (30) with respect to the tubular element (60) when the handle (30) is in a locked position, and further configured to allow rotational movement of the handle (30) with respect to the tubular element (60) when the handle (30) is brought from the locked position to an intermediate position by relative movement of the handle with respect to the sample receiving element (50) and/or the tubular element (60) in the direction of the longitudinal axis.

2. Sampling device (100) according to claim 1, wherein the locking mechanism comprises a locking projection on the handle side and a control track on the tubular element side, wherein the control track fixes the locking position by the locking projection engaging in a locking recess of the control track, and sets the intermediate position by the locking projection being guided in a sliding manner on the control track.

3. Sampling device according to claim 1, wherein the locking mechanism defines a plurality of locking positions and respective intermediate positions lying between the locking positions, wherein a respective locking position corresponds to a position of the handle to the tubular element (60) in which a sample can enter the sample receiving chamber (51) via the opening (62) or the opening (62) is closed.

4. Sampling device (100) according to claim 1, wherein the sample receiving element (50) comprises a plurality of sample receiving chambers (51) spaced apart in the circumferential direction and in the longitudinal direction in the same axial arrangement and at least one closure portion.

5. Sampling device (100) according to claim 1, wherein the locking mechanism comprises a biasing mechanism that biases the handle in the direction of the tubular element (60) at least in sections.

6. Sampling device (100) according to claim 5, wherein the biasing mechanism is formed by a connecting element (80), a handle portion (30₂) of the handle and a spring element (70),
wherein the connecting element (80) has an end portion (81) on the sample receiving element side and an end portion (82) on the handle side,
wherein the end portion (81) on the sample receiving element side is connected to the sample receiving element (50) in a rotationally fixed manner and is mounted in the tubular element (60) in a rotationally movable manner and is fixed in an axially immovable manner in the direction of the handle,
wherein the end portion (82) on the handle side interacts with the handle portion (30₂) in such a way that the end portion (82) is mounted so as to be axially movable and non-rotatable in relation to the handle portion (30₂), and the spring element (70) is arranged between the end portion (82) on the handle side and a step (34) of the handle portion (₃₀₂) in such a way that the spring element (70) can be compressed or expanded during relative movement between the end portion (82) on the handle side and the handle portion (30₂6).

7. Sampling device (100) according to claim 6, wherein the handle (30) further comprises a compression portion which is rigidly connected to the connecting element (80) and is movable relative to the handle such that upon relative movement of the compression portion relative to the handle, the spring element (70) is compressed or expanded.

8. Sampling device (100) according to claim 1, wherein the tubular element (60) is provided at one end with the handle (30) and at another end with a removable tip portion (90), which, as intended, is first inserted into the sample volume containing the sample when the sample is taken, wherein the sample receiving element (50) can be removed from the tubular element (60) when the tip portion (90) is removed.

9. A sampling method for taking a sample from a total sample volume using a sampling device (100) according to claim 1, wherein the method comprises the following steps:
insertion of the sampling device (100) into the total sample volume while the handle is in the locked position and the opening is closed,
moving the handle (30) at least in the direction of the longitudinal axis relative to the sample receiving element into an intermediate position;
turning the handle (30) into a further locking position so that the sample receiving chamber is accessible via the opening for taking the sample;
insertion of the sample into the sample receiving chamber (51);
moving the handle (30) at least in the direction of the longitudinal axis relative to the sample receiving element into an intermediate position;
rotating the handle (30) relative to the tubular element so that the opening is closed or another sample receiving chamber is accessible via the opening for taking the sample.

10. A method for cleaning a sampling device (100) according to claim 1, the method comprising the following steps:
compressing the compression portion of the handle (30) so that the compression portion moves relative to the tubular element (60) in the direction of the tubular element (60), wherein the sample receiving element is at least partially pushed out of the tubular element.

11. Sampling device (100) for taking a sample, the sampling device (100) comprising:
an elongate sample receiving element (50), which has at least one sample receiving chamber (51),
a hollow cylindrical tubular element (60) comprising at least one opening (62) and accommodating the sample receiving element (50) in an interior space (61) mounted so as to be rotatable about a longitudinal axis of the sampling device (100) in such a way that, upon relative rotation between the sample receiving element (50) and the tubular element (60), a sample can pass through the opening (62) into the sample receiving chamber (51) and/or the opening (62) can be closed,
a handle (30) which is coupled to the sample receiving element (50) in such a way that a translatory relative movement of the handle (30) along the longitudinal axis in relation to the sample receiving element (50) is converted into a rotational movement of the sample receiving element (50), preferably by means of a screw drive with a handle (30) configured at least partially as a threaded shaft and a sample receiving element (50) configured at least partially as an internally threaded spindle.
